(19) United States
(12) Patent Application Publication
(10) Pub. No.: US 2009/0024837 A1
(43) Pub. Date: Jan. 22, 2009

(54) System and Method for Language Specification

(76) Inventor: Joel Brand, Holtsville, NY (US)

Correspondence Address: Fay Kaplun & Marcin, LLP/ Motorola, 150 Broadway Suite 702, New York, NY, 10038, US

(21) Appl. No.: 11/778,767

(22) Filed: Jul. 17, 2007

(51) Int. Cl. G06F 9/30

(52) U.S. Cl. 712/214; 712/E09.016

(57) ABSTRACT

Described are a system and method for language specification. The device may include (a) a processor running an operating system and (b) an image capturing device scanning an image. The operating system is configured to display a user interface. The image includes data that is transmitted to the operating system to execute a language installation protocol. The protocol indicates a display language for the user interface.

### FIELD OF THE INVENTION

The present invention relates generally to a system and method for specifying a language for an electronic device. Specifically, an encoded message may be scanned using the electronic device to specify the language.

### BACKGROUND

An electronic device may utilize an operating system to manage and execute a variety of functionalities that may be carried out by the electronic device. The operating system may display a user interface so that appropriate commands may be input by a user. A default language setting for the user interface may be pre-selected for the operating system by an original equipment manufacturer. However, if the default language that was set is not a primary language or a comfortable language to be used by the user, the user may be required to alter the language setting at a later time.

Conventional operating systems may allow a user to select a default language at an initial startup. For example, when the electronic device first loads the operating system, an input screen may be loaded instructing the user to enter a default language. In another example, an input screen may be loaded instructing the user to enter a location such as a country to determine a default language to be entered. The language and/or location may be part of a selectable menu. Because this method of entering the default language is wholly dependent on the user manually locating and entering the appropriate language/location, errors may occur where a user incorrectly inputs the language/location. Unfortunately, the operating system records the chosen language/location and the user is stuck with the incorrect selection. To reenter the default language, a hard reboot or a reflash of the electronic device is necessary.

### SUMMARY OF THE INVENTION

The present invention relates to a system and method for language specification. The device may include (a) a processor running an operating system and (b) an image capturing device scanning an image. The operating system is configured to display a user interface. The image includes data that is transmitted to the operating system to execute a language installation protocol. The protocol indicates a display language for the user interface.

The method may include the following steps. An image is scanned with an image capturing device. The image includes data to execute a language installation protocol which indicates a language. The data is transmitted to a processor of an electronic device. The protocol is executed to set the language for a user interface of an operating system of the electronic device.

### DESCRIPTION OF THE DRAWINGS

FIG. 1 shows an electronic device according to an exemplary embodiment of the present invention.

FIG. 2a shows a one-dimensional barcode.

FIG. 2b shows a two-dimensional barcode.

FIG. 3 shows a method of entering a default language for an operating system of an electronic device according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe a system and method for entering a language for an operating system for an electronic device (e.g., personal computer, laptop, pager, mobile device, cell phone, radio frequency identification device, scanner, a data acquisition device, an imager, etc.). According to the exemplary embodiments of the present invention, the operating system of the electronic device sets a default language to be used in a user interface. The default language may be set by scanning a barcode or other encoded data. The barcode or other encoded data may contain instructions for the operating system to execute to set the default language. The operating system and the default language setting will be discussed in more detail below.

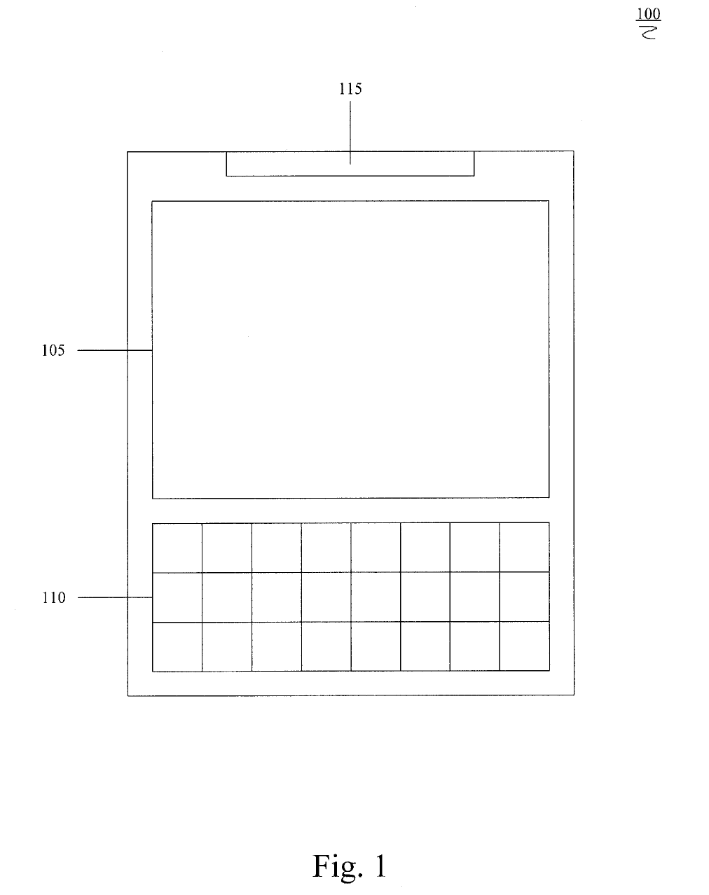

FIG. 1 shows an electronic device 100 according to an exemplary embodiment of the present invention. The electronic device 100 may be any device that includes a processor such as those described above. The processor may run an installed operating system. The operating system may be, for example, Windows, Unix, DOS, etc. The operating system may be stored on a memory disposed within the electronic device 100. As illustrated, the electronic device 100 may be a mobile unit that includes substantially all the components of the electronic device 100 in a singular unit. The electronic device 100 may include, for example, a display 105, a data input arrangement 110, and a scanner 115.

The display 105 may provide a visual medium for the user interface. The display 105 may be a liquid crystal display (LCD) disposed at least partially within the housing of the electronic device 100. The display 105 may be equipped with a touch screen that receives inputs from a user making contact with various portions of the surface area of the display 105. It should be noted that the display 105 being an LCD and/or disposed as part of the electronic device 100 is only exemplary.

In another embodiment, the electronic device 100 may house the processor, the memory, and/or other components such as a transceiver, an antenna, a video card, and a sound card but the display 105 may be disposed as a separate unit. For example, the electronic device 100 may be a computer tower. The display 105 may be a monitor that electrically connects to the computer tower. The monitor may be a cathode ray tube (CRT) monitor or an LCD.

The data input arrangement 110 may be a key pad disposed at least partially on a periphery of the housing of the electronic device 100. The data input arrangement 110 may be substantially similar to a key pad found on conventional mobile units such as a key pad arranged alphabetically, a key pad arranged in a QWERTY format, a key pad including a number pad, etc. The keys of the key pad may be conventional spring loaded, pushable buttons. The keys of the key pad may also be sensors such as light sensors, heat sensors, etc.

In another embodiment, similar to the display 105, the data input arrangement 110 may be disposed as a separate unit from the electronic device 100. For example, the data input arrangement 110 may be a keyboard that electrically couples to the electronic device 100. The electronic device 100 may include a port (e.g., serial, universal serial bus, etc.) that accepts a connector from the data input arrangement 110. The keyboard may be substantially similar to a conventional keyboard utilized with desktop computers.

The scanner 115 may be a data capturing device such as a barcode scanner, an imager, a camera, etc. The scanner 115 may be housed substantially within the housing of the electronic device. Those skilled in the art will understand that the scanner 115 may require a line of sight to an item that is to be scanned. Thus, a window may be disposed on a periphery of the housing of the electronic device 100, thereby allowing a scanning engine of the scanner 115 to capture a scan of the item. The scanner 115 may include a trigger that may also be disposed on a periphery of the housing of the electronic device 100. For example, the trigger may be disposed on a side face of the housing. In another example, the trigger may be a key on the data input arrangement 110.

In another embodiment, similar to the display 105 and the data input arrangement 115, the scanner 115 may be disposed as a separate unit from the electronic device 100. Those skilled in the art will understand that mobile units may not be equipped with the scanner 115. Thus, a separate scanner may be electrically connected to the electronic device 100. The separate scanner may include all the circuitry such as the scanning engine, the trigger, a display, etc. The separate scanner may also apply to an electronic device that is not a mobile unit such as the desktop tower described above.

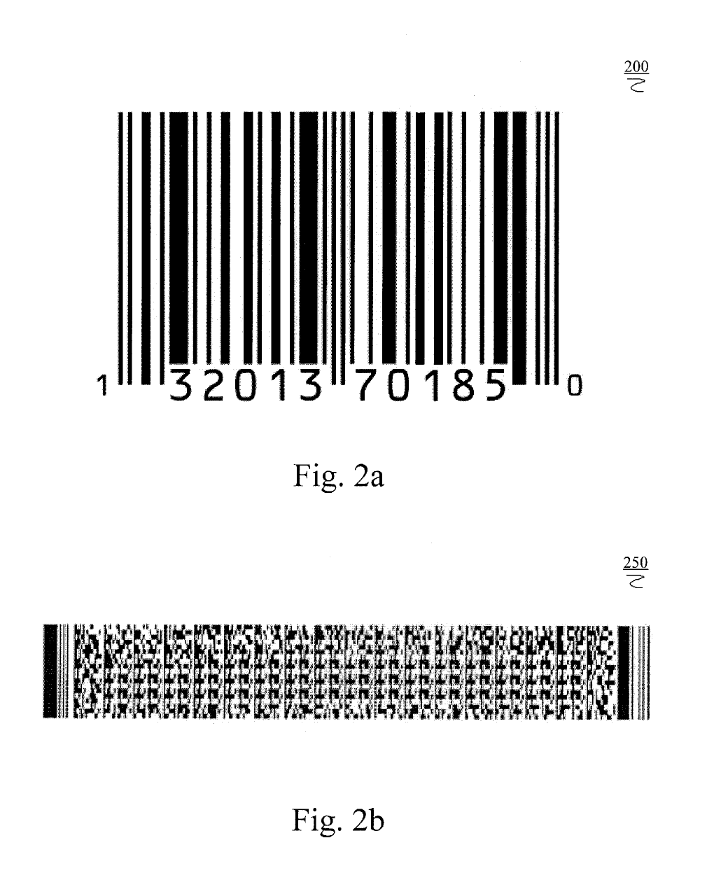

FIG. 2a shows a one-dimensional (1D) barcode 200.

FIG. 2b shows a two-dimensional (2D) barcode 250. The 1D barcode 200 and the 2D barcode 250 may be scanned using the scanner 115. Those skilled in the art will understand that the scanner 115 may be a barcode scanner to scan the 1D barcode 200 or an imager to scan the 2D barcode 250. Those skilled in the art will also understand that the 2D barcode 250 may include a relatively higher amount of data encoded therein compared to the 1D barcode 200. Thus, the 2D barcode 250 may be used to include additional instructions to be executed by the processor of the electronic device 100. It should be noted that the use of the barcodes 200, 250 is only exemplary. Depending on the type of scanner that is being used, the object to be scanned may be different. For example, if the scanner 115 is a camera, the image that is scanned may be a picture.

The 1D barcode 200 and the 2D barcode 250 may be located in a variety of areas. For example, when the electronic device 100 is delivered to a user from the manufacturer, the barcode may be printed on a packaging box. Furthermore, depending on the country or locale in which the electronic device 100 is to be delivered, a corresponding barcode may be printed on the box. In another example, an instruction page may be included when delivering the electronic device 100. The instruction page may include the barcode with a specific language. The language may be based on, for example, a user request, a primary language used in the country in which the electronic device 100 is delivered, etc. In yet another example, a list of barcodes may be printed in a user manual. Each barcode may be encoded to install a different language as the default language of the operating system. The barcodes may also be printed on individual pages so that an erroneous scan may not occur.

The barcodes 200, 250 may be used in a variety of ways to install a default language for the operating system of the electronic device. In a first embodiment, the barcodes 200, 250 may be scanned by a user when prompted by the operating system. Thus, in contrast to a user being required to locate and input the default language, a scan may be performed using the scanner 115 to denote the default language.

In another embodiment, the process of setting the default language may be automatic without a prompt. The 1D barcode 200 and the 2D barcode 250 may be exemplary embodiments of encoded data including instructions to set a default language for the operating system of the electronic device 100. The barcodes 200, 250 may, for example, instruct the operating system to execute a set of commands to set the default language. The set of commands may be programmed in a variety of manners depending on the electronic device and the operating system.

In a first embodiment of the set of commands, the barcodes 200, 250 may include a first data instructing that the operating system initializes the language selection feature. A second set of data may include a language code indicating the default language to which the operating system is to be set. A third data may instruct the operating system to conclude the language selection feature.

In a second embodiment of the set of commands, the barcode 250 may include more detailed instructions for the operating system. As discussed above, the barcode 250 may include a relatively higher amount of data encoded therein. For example, the barcode 250 may also include the first data described above. However, the operating system may not permit a scan to be used to execute commands. Thus, the barcode 250 may include a second data indicating a procedure regarding a third set of data. The third set of data may be directed into a buffer of the data input arrangement 110. The stored data may simulate a user inputting data via the data input arrangement 110. Thus, a virtual selection of the default language may be executed. It should be noted that the above process of installing the default language may apply to any electronic device that may or may not include the scanner 115. That is, a separate scanner that is connected may be used. It should be noted that the barcode 200 may also include the above instructions.

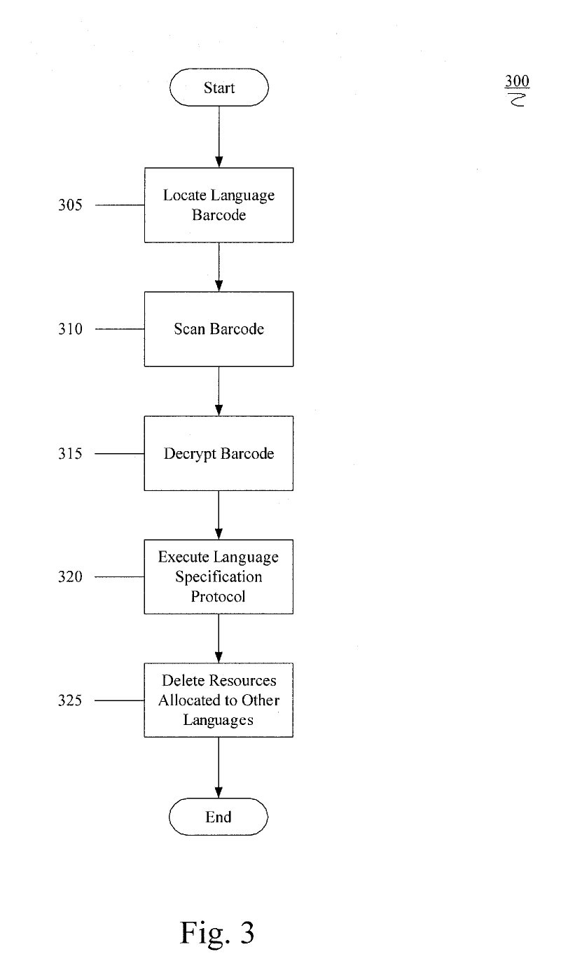

FIG. 3 shows a method 300 of entering a default language for the operating system of the electronic device 100 according to an exemplary embodiment of the present invention. The method 300 will be described with reference to the electronic device 100 of FIG. 1 and the barcodes 200, 250 of FIGS. 2a-b. It should be noted that the method 300 being described with the electronic device 100 being a mobile unit is only exemplary. As discussed above, the method 300 may apply to any electronic device that has an operating system with a user interface. The following description will use the barcode 200. However, as discussed above, the barcode 250 may also be used.

It should be noted that prior to the onset of the method 300, a step may exist where a prompt is displayed to a user. For example, the prompt may request a user to set the default language. As discussed above, the operating system may not be equipped with scanning capabilities and, therefore, assumes that a user will manually set the default language. However, as will be discussed below, the exemplary embodiments of the present invention may set the default language with or without the prompt.

In step 305, the barcode 200 is located. As discussed above, the barcode 200 may be located in a variety of areas such as on the packaging box, an instruction sheet, a user manual, etc. Thus, if the barcode 200 is located on the packaging box, the user may locate the area in which the barcode 200 is printed. If the barcode 200 is located on an instruction sheet, the user may locate the sheet in which the barcode 200 is printed. It should be noted that if the barcode 200 is printed on the packaging box or the instruction sheet, a single barcode 200 may be printed. The single barcode 200 may include the instructions to install the default language. As discussed above, the default language may be determined by user request, primary language of the locale, etc. In addition, when a prompt is displayed, the user may locate the appropriate barcode 200 upon receiving the prompt to set the default language.

If the barcode 200 is located in a user manual, the user may find the location in the manual including the barcode 200. The user manual may be tailored. For example, the user manual may be written in the same language as the default language, where the default language was determined by user request, language of the locale, etc. Thus, in one embodiment, a single barcode 200 may be printed on a page of the user manual for the default language. In another embodiment, a list of barcodes 200 may be printed on a page or pages of the user manual where each barcode 200 may be for a different default language installation. Consequently, the user may locate the appropriate barcode 200. In yet another embodiment, each barcode 200 of the list of barcodes 200 may be printed on an individual page to eliminate any possibility of an incorrect scan by the user.

In step 310, the barcode 200 is scanned. As discussed above, the electronic device 100 may be a mobile unit that includes the scanner 115. Using the scanner 115, the encoded data of the barcode 200 may be read. Also, as discussed above, a separate scanner may electrically couple to the electronic device 100. The separate scanner may be used to read the encoded data of the barcode 200.

In step 315, the barcode 200 is decrypted. Once the barcode 200 is read by the scanner 115, the data may be transmitted to the processor of the electronic device 100. The processor may receive and interpret the data. In another embodiment, the scanner 115 or the separate scanner may be equipped to read and decrypt the barcode 200. Thus, the data that is transmitted to the processor may be instructions, language specifications, etc. That is, the processor may not be required to decrypt the barcode 200.

In step 320, the default language specification protocol is executed. As discussed above, the default language specification protocol may be performed in a variety of ways depending on factors such as the electronic device 100, the operating system installed, etc. For example, if the scanner 115 may transmit instructions to the processor including a set of steps to be performed, the instructions may be received and executed. In another example, if the processor or operating system does not permit data directly from the scanner 115 to be used to execute the default language specification protocol (e.g., the operating system requires a user input), the data of the barcode 200 may be stored in the buffer of the data input arrangement 110, thereby a virtual user input being created.

In step 325, resources allocated to other languages may be deleted. Once the default language has been set with the above steps, other languages become unnecessary and may be deleted to free up space on, for example, the memory. It should be noted that step 325 is only exemplary and the method 300 may not include step 325. If the memory of the electronic device 100 includes enough capacity, the resources may be kept. Furthermore, the method 300 may allow further languages to be installed. The user may scan a different barcode to install another language. The user manual may include multiple barcodes 200 that correspond to a different language. Thus, if the user wishes to install multiple languages for use with, for example, different functionalities, the barcode 200 with the different language may be scanned and subsequently installed.

The exemplary embodiments of the present invention allow a user to correctly input a default language for the operating system of the electronic device 100. By eliminating unnecessary steps to install the default language, a user will not be required to format or flash the electronic device to return to the initial language selection process. In addition, through scanning the barcode to set the default language, the time required for this process may be decreased. Furthermore, because the individual time to set the default language decreases, a system administrator may benefit by decreasing an overall time required to set default languages for a plurality of devices. For example, when the system administrator has to perform a large installation, the system administrator may only be required to scan the appropriate barcode instead of manually entering the default language for each device. When a common default language is set for multiple machines, the administrator may also repeatedly use the same barcode, thereby further decreasing the overall time required.

It should be noted that the setting of the default language for an operating system is only exemplary. A user may install various programs in the electronic device. The user may desire to set a default language for each program that is installed. For example, a word processing program may be installed onto the device. The user may wish to set a different default language on the word processing program than the default language set for the operating system. Thus, the exemplary embodiments of the present invention may also be used to set a default language for programs other than operating systems.

Those skilled in the art will understand that the above described exemplary embodiments may be implemented in any number of manners, including, as a separate software module, as a combination of hardware and software, etc. For example, the protocol to execute a setting of a default language may be encoded as a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a processor running an operating system, the operating system configured to display a user interface; and
an image capturing device scanning an image, the image including data that is transmitted to the operating system to execute a language installation protocol, the protocol indicating a display language for the user interface.

2. The device of claim 1, wherein the device is a mobile unit.

3. The device of claim 1, further comprising:
a display displaying the user interface.

4. The device of claim 1, wherein the image capturing device is one of a barcode scanner, an imager, and a camera.

5. The device of claim 1, wherein the image is one of a one-dimensional barcode, a two-dimensional barcode, and a picture.

6. The device of claim 1, wherein the user interface includes a prompt to enter a default language.

7. The device of claim 1, wherein the language installation protocol includes a set of instructions to be executed by the processor.

8. The device of claim 7, wherein the set of instructions automatically installs the language.

9. The device of claim 7, wherein the set of instructions emulates a manual entering of the language.

10. The device of claim 9, wherein the manual entering is emulated by simulating keystrokes of a data input arrangement.

11. A method, comprising:
scanning an image with an image capturing device, the image including data to execute a language installation protocol, the protocol indicating a language;
transmitting the data to a processor of an electronic device; and
executing the protocol to set the language for a user interface of an operating system of the electronic device.

12. The method of claim 11, wherein the image capturing device is one of a barcode scanner, an imager, and a camera.

13. The method of claim 11, wherein the image is one of a one-dimensional barcode, a two-dimensional barcode, and a picture.

14. The method of claim 11, further comprising:
displaying a prompt to enter a default language.

15. The method of claim 11, further comprising:
executing, by the processor, a set of instructions included in the language installation protocol.

16. The method of claim 15, wherein the set of instructions automatically installs the language.

17. The method of claim 15, wherein the set of instructions emulates a manual entering of the language.

18. The method of claim 17, wherein the manual entering is emulated by simulating keystrokes on a data input arrangement electrically connected to the electronic device.

19. A device, comprising:
a processing means for running an operating system, the operating system configured to display a user interface; and
an image capturing means for scanning an image, the image including data that is transmitted to the operating system to execute a language installation protocol, the protocol indicating a display language for the user interface.

20. A system, comprising:
an electronic device including a processor running an operating system, the operating system configured to display a user interface; and
an image capturing device scanning an image, the image including data that is transmitted to the operating system to execute a language installation protocol, the protocol indicating a display language for the user interface.

21. A computer readable storage medium including a set of instructions executable by a processor, the set of instructions operable to:
scan an image with an image capturing device, the image including data to execute a language installation protocol, the protocol indicating a language;
transmit the data to a processor of an electronic device; and
execute the protocol to set the language for a user interface of an operating system of the electronic device.
